(19) United States
(12) Patent Application Publication
(10) Pub. No.: US 2026/0355752 A1
(43) Pub. Date: Nov. 12, 2026

(54) Waste Food Machine with Sabbath-Compliant Operation System

(71) Applicants: Iain Milnes, Fremont, CA (US); Agile Johns, San Jose, CA (US)

(72) Inventors: Iain Milnes, Fremont, CA (US); Agile Johns, San Jose, CA (US)

(73) Assignee: Power Knot LLC, Fremont, CA (US)

(21) Appl. No.: 19/200,163

(22) Filed: May 6, 2025

(51) Int. Cl. B02C 25/00

(52) U.S. Cl. CPC B02C 25/00

(57) ABSTRACT

A waste food machine configured for Sabbath mode operation is disclosed. The machine prevents the stopping of the machine when the door is opened for waste to be deposited by accepting waste through a hopper while maintaining continuous or continual rotation of drum arms. During Sabbath mode, the primary door is locked to prevent manual, hydraulic, or motorized opening, using methods such as energizing an electromagnet, extending a solenoid plunger, disabling a linear motor actuator, or disabling a hydraulic drive. In some embodiments, waste is directed through spring-loaded or gravity flap doors or manually operated doors within the hopper to maintain drum sealing. Sabbath mode activation can be triggered by a physical switch, a designated touchscreen area, preprogrammed dates and times synchronized with an onboard real-time clock, internet-connected timekeeping protocols (such as NTP or SNTP), or external server queries based on halachic parameters.

### BACKGROUND OF THE INVENTION

A waste food machine disposes of waste food or reduces its volume and weight; such machines have been in use for about 25 years. Waste food machines may vary in size, with typical institutional machines processing from 20 kg per day to 3000 kg per day. Such devices may vary from about 50 cm wide to 400 cm wide. Many such machines are constructed mostly of stainless steel.

The waste food machine is a machine that is usually installed in an institutional kitchen. It is used by an organization or business that produces large quantities of waste food. The machines save or reduce the mess, cost, and inconvenience of sending the waste food to a landfill. When waste food is sent to a landfill it generally decomposes to methane (CH4) which is released to the atmosphere. CH4 is 84 times worse for the atmosphere than CO2. Businesses that generate waste food are realizing the implications of their waste food on the environment and the use of a waste food machine can help to significantly reduce their carbon footprint.

The present invention applies to any type of such waste food machine. There are two basic types of waste food machine: a wet type and a dry type.

With the wet type of machine, waste food is put into the machine where it is decomposed in an aerobic manner and the output is sent as grey water down the drain. With the dry type of machine, waste food is dehydrated reducing the volume significantly. The output can be sent to a landfill, sent for further processing to make compost, or used as a soil amendment.

FIG. 1 is a partially cut away side view of an exemplary waste food machine, in accordance with the prior art.

For a wet type of machine and referring to FIG. 1, a chassis 0101 supports a drum 0102 and a motor 0103. In general, waste food is put into drum 0102 through a door 0104. Motor 0103 drives a shaft 0105 with arms 0106 through a chain, belt, or system of gears 0107. Motor 0103 causes arms 0106 to rotate slowly (for example at about one revolution every five to 12 seconds) to mix old waste food with new waste food. Water may be added to the drum through an inlet 0108 to maintain the correct moisture content in drum 0102 for the decomposition process. The decomposition of the waste food may be accelerated by the addition of microorganisms, enzymes, or a blend of microorganisms and enzymes 0109 that are added periodically to drum 0102 either automatically or manually through door 0104.

In a typical machine, digested material exits the drum 0102 through a drain pipe 0110 and thereby the digested liquid and tiny particles may flow out of the machine to a drain. Chassis 0101 is often supported on supports 0111, of which there are typically four. In some machines, these supports may be combined with wheels to allow the machine to be moveable or the wheels may be separate. The supports may be the feet of load cells that allow the machine to weigh the waste food. An outer casing 0112 is usually made of stainless steel.

With a wet type of machine, the aerobic process of digestion when operating properly will not create CH4 and typically has no bad odors. The process is exothermic and the inside of the drum is typically at about 43 °C.

For a dry type of machine, the structure is similar to the wet type. However, water and microorganisms are not typically added to the machine. Usually, the machine is loaded with waste food, the door is closed, and the machine heats the waste food. Typically, the temperature is raised to 90 °C for six to 10 hours and a cycle takes about 18 hours. The machine may churn the waste during this process with the objective of breaking it into small pieces. At the end of the cycle, the dehydrated waste is emptied through an output door 0113, which is typically not present on the wet type of machine. The dehydrated waste is typically 8% to 15% of the original volume of waste food. This batch type of machine is not applicable for the current invention.

A hybrid type machine may start with a decomposition process similar to a wet type of machine, and, after a certain time, for example, 12 hours, the machine may then dry the remainder of the waste food similar to a dry type of machine. Further, some hybrid machines do not process the waste food as a batch, but instead, the process is continuous so that waste food may be added at any time. Such a machine is applicable to the present invention.

When an operator wants to put the waste food into the machine, he or she needs to firstly open the door of the machine. The majority of waste food machines have doors that are opened manually. Some machines may have doors that open by an electric motor or by a hydraulic piston. In the cases which are not manual, the operator has to scan a card or press a button to initiate the opening and closing of the door.

When the door is opened any activity of the waste food machine stops. The arms require significant force to turn the waste in the drum of the machine. If a user puts any part of his or her body in the machine while the arms are turning, this can lead to injury or death.

### SUMMARY OF THE INVENTION

In one aspect, a method for operating a waste food machine in Sabbath mode is provided that enables a configuration that prevents the stopping of the arms by opening the door. In one aspect, the machine accepts waste food through a hopper without the need to open the primary door. In one aspect, the drum arms continue rotating during waste deposition via the hopper. In one aspect, the primary door is locked during Sabbath mode to prevent manual, hydraulic, or motorized opening.

Advantages of one implementation may include one or more of the following:
Compliance with Observance Requirements—The method promotes adherence to religious or traditional mandates by ensuring that no manual, hydraulic, or motorized operations are required during designated observance periods.
Enhanced User Convenience—By operating in Sabbath mode, the machine eliminates the need for direct human interaction (such as opening a door) during waste deposition. This enables users to manage daily tasks without concern for inadvertently violating observance rules.
Continuous Operational Efficiency—The design allows the drum arms to maintain rotation during waste deposition via a dedicated hopper. This continuous operation minimizes potential stoppages and ensures efficient waste processing even when the primary door remains locked.
Reduced Risk of Manual Interference—Locking the primary door during Sabbath mode not only prevents direct human intervention but also minimizes the likelihood of accidental triggering of operational controls, ensuring a seamless and uninterrupted mode of operation.
Preserved Machine Functionality—The system's architecture is tailored to accommodate the unique constraints imposed by observance requirements while still delivering reliable performance. As such, it maintains or improves upon the efficiency of traditional waste food machines.
Adaptive Design for Household and Organizational Needs—One implementation offers a versatile solution that can be integrated into various domestic and institutional setups, enabling organizations to modernize operational protocols without compromising traditional observance practices.

These advantages collectively address both practical functionality and the need for adherence to specific, long-standing observances, thereby offering a robust solution tailored to the evolving requirements of modern households and organizations.

### BRIEF DESCRIPTION OF DRAWINGS

FIG. 1 shows a conventional waste food machine.

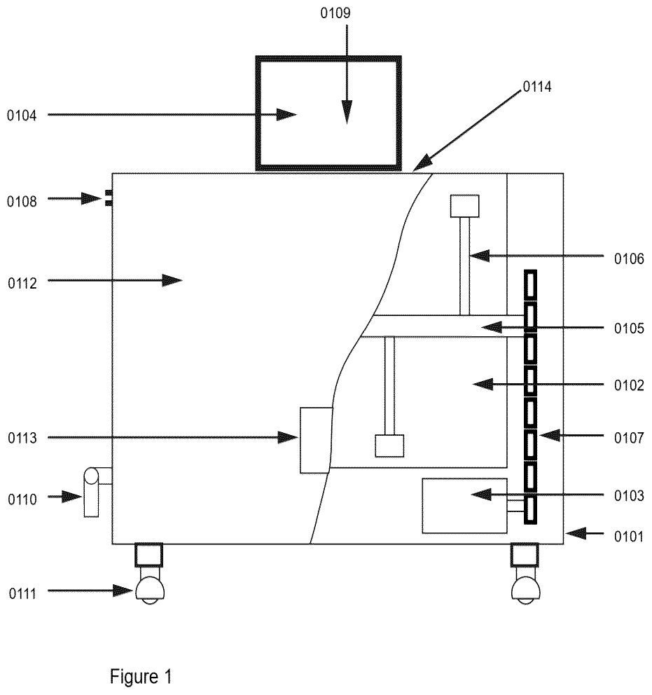

FIGS. 2a and 2b show an exemplary waste food machine with the Sabbath mode.

FIGS. 3 and 4 show an exemplary food hopper.

FIGS. 5 to 7 show exemplary Sabbath mode actuators.

FIG. 8 illustrates a flowchart for operating a waste food machine with a Sabbath-compliant system.

### DETAILED DESCRIPTION OF THE INVENTION

A common interpretation of Jewish law is that a person should not directly or indirectly cause a machine to perform work—or to stop performing work—on the Sabbath. Therefore, the opening of the door to cause the motor to stop is generally not acceptable. However, one can argue that opening the door and causing the motor to stop is to prevent danger. This could be seen as a permissible action under pikuach nefesh (the principle that saving a life or preventing danger overrides other Sabbath prohibitions). However, the counter argument is that a user is not in danger by opening the door—the danger arises if the user puts part of his or her body into the machine, which is not a normal way to use the machine. The system described herein creates a Sabbath mode on the waste food machine that is deemed by a third party certification authority as being kosher to indicate it complies with the halacha (Jewish law).

In one aspect, an apparatus for providing Sabbath mode operation of a waste food machine is detailed. The waste food machine has a housing, at least one drum enclosed in the housing, arms within the drum that may continually or continuously rotate, and at least one door. The door can be opened normally at any time, whether manually, by hydraulics, or an electric motor. The opening of the door normally stopping the arms of the machine from turning for safety, regardless whether they were turning or not at the time the door is opened. The apparatus includes a hopper where the waste food can be placed into the machine without opening the door and hence without the possibility of stopping the arms from moving.

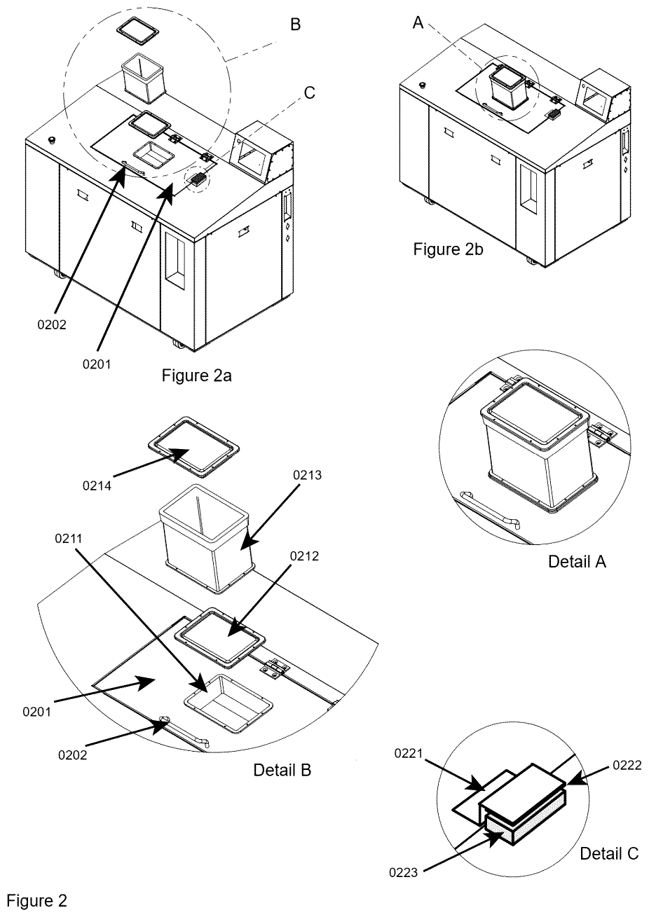

The operation of the hopper shown in FIGS. 2a and 2b are detailed next. FIG. 2a shows an exploded view of the hopper in pieces and FIG. 2b shows a typical hopper fully assembled. FIGS. 2a and 2b focus on the hopper system designed to enable waste food deposition without opening the main door, which is particularly relevant for Sabbath mode operation. FIG. 2a shows the hopper in its disassembled state, highlighting the door 0201, handle 0202, base 0211 that seals against the door, lower flap lid 0212, chute 0213, and upper flap lid 0214. The assembly ensures that waste can be added while maintaining a seal and preventing user access to internal moving parts. Detail C in FIG. 2a illustrates an electromagnet 0223 mounted to the machine's top panel, which, in conjunction with a bracket 0221 and steel plate 0222, locks the door during Sabbath mode. FIG. 2b presents the fully assembled hopper mounted on the door, emphasizing its accessibility and safety features.

The figures show the hopper mounted on the door 0201, but the hopper could be mounted not on the door but anywhere on the top panel. For practical purposes, the position of the hopper should be where it can be easily accessed by a user to deposit the waste food.

In normal mode, the door is opened by an operator using handle 0202. If the hopper is fixed to the door it should preferably be light so that opening the door is not unduly burdened by the weight of the hopper and the door should open as usual without the hopper hitting the top panel of the machine.

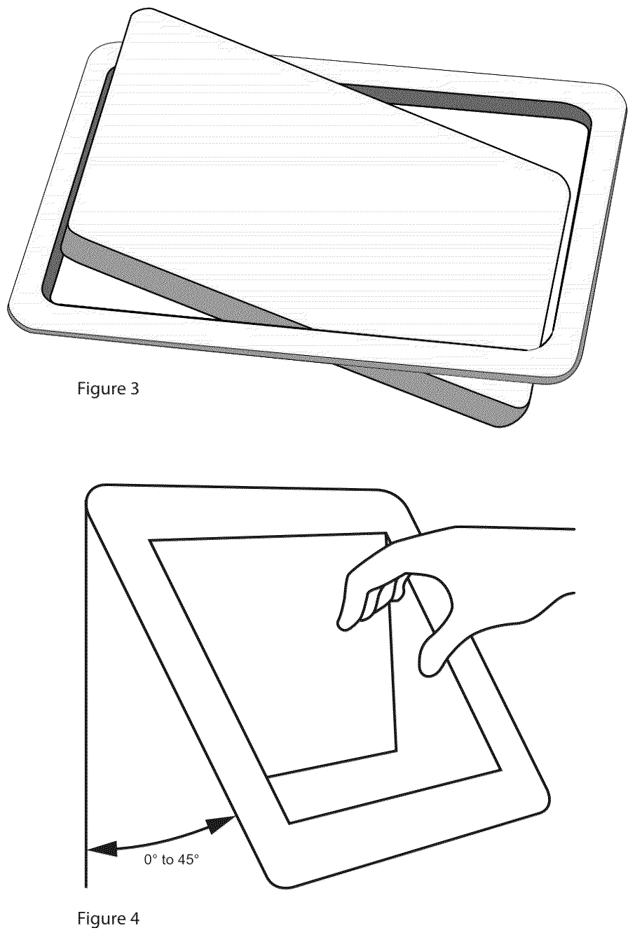

Detail B shows how the hopper can be configured, but one can imagine that other designs are possible. The base 0211 fits through the thickness of the door and forms a seal around the door. 0212 is a flap lid like that shown in FIG. 3. The flap lid is hinged in the middle and constructed such that the lid lies horizontal normally, and will fall horizontal when moved from the horizontal position.

On top of the lower flap lid is a chute 0213 and on top of that another similar flap lid 0214. The height of the chute 0213 is such that when the two flap lids 0212 and 0214 are vertical that they are not touching. The height of the chute is also designed so that a user cannot reach through the hopper system to touch the arms of the waste food machine.

Detail A shows the hopper system fully assembled. The two flap lids help to maintain the heat and moisture in the drum. However, it is conceivable that the hopper system can be constructed with only one flap lid which could be placed at the bottom, top, or anywhere in between of the chute. It is also possible to use a different type of flap lid than that shown in FIG. 3.

Specifically, there are flap lids that are hinged at one side and use a spring to return the lid to its closed position. Such a flap is shown in FIG. 4 where the hopper can be designed so that the flap lid is at an angle from the vertical up to 45°. When the angle gets to be greater than 45°, the spring required to return the flap to its closed position is strong, and it becomes awkward for a user to open the flap to deposit the waste food. FIG. 4 introduces an alternative hopper design featuring a side-hinged, spring-loaded flap lid. This configuration allows the flap to be set at an angle up to 45 degrees, balancing ease of use with the need to maintain a seal and prevent accidental access to the drum's interior. The spring mechanism ensures the flap returns to its closed position, helping to preserve the internal environment of the machine. Other configurations of the door for the hopper can be envisaged, including a hinged door that is manually opened and closed.

When the Sabbath mode is engaged, the door is locked and cannot be opened. The user will deposit waste into the drum of the waste food machine through the hopper. At the end of Sabbath, the door is unlocked and can be used once more to put the waste into the machine.

Next, the operation of the door lock is detailed. One method for locking the door is shown in FIG. 2a and Detail C. It uses an electromagnet 0223 mounted to the top panel of the machine. A bracket 0221 is mounted to the door of the machine and a steel plate 0222 is fixed to the bracket. The magnet 0223 is engaged to lock the door by attracting the steel plate 0222. The force of the magnet and its distance from the hinges of the door should be designed so that at least 200 N of force is required to open the door by using the handle 0202.

It is possible to mount the magnet in a different manner. Such examples are (a) to include the steel plate into the door; (b) put the electromagnet inside the door; (c) recess the magnet into the top panel.

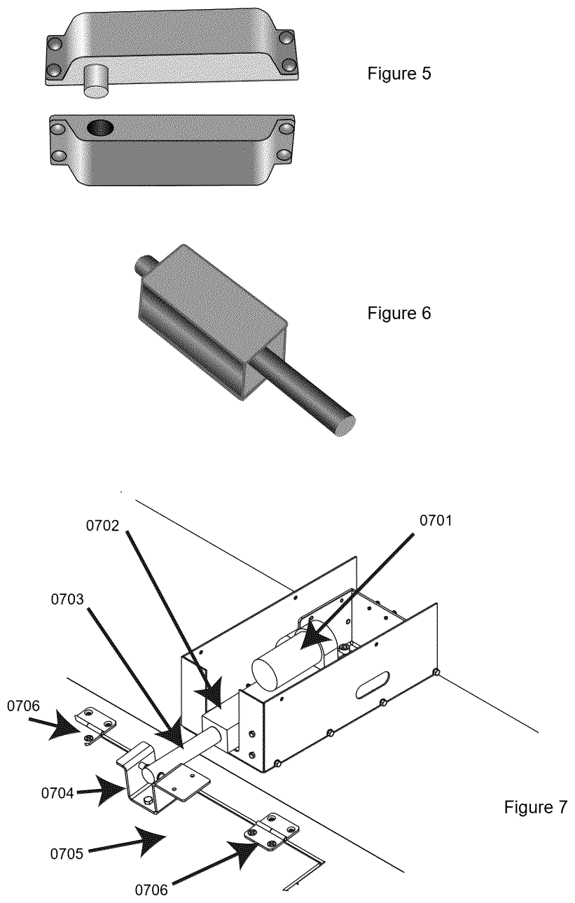

Examples of alternative methods to lock to door are with a mortice lock as shown in FIG. 5 or a solenoid plunger lock as shown in FIG. 6. FIG. 5 illustrates a mortice lock mechanism as another option for securing the door during Sabbath mode. The lock consists of two parts: one attached to the door and the other to the top panel of the machine. When engaged, the mortice lock prevents the door from being opened, thereby ensuring compliance with Sabbath restrictions.

FIG. 6 depicts a solenoid plunger lock, which operates by extending or retracting a plunger into a bracket with a hole. Either the plunger or the bracket can be mounted on the door or the machine's top panel, providing a secure and electrically controlled locking mechanism that can be engaged or disengaged as needed for Sabbath mode.

The bar is withdrawn or extended to lock or unlock the door. In the case of FIG. 5, this is a mortice lock in two parts, one of which would be fixed to the door and the other to the top of the machine's panel. In the case of the plunger lock in FIG. 6, a bracket would have a hole in it and one of the plunger or bracket is fitted to the door while the other is fitted to the top of the machine. Alternatively, the plunger could be set to go into a hole on the side of the door or on a bracket below the door.

A door may be opened and closed with a linear motor as shown in FIG. 7. The linear motor comprises an electric motor 0701, connected to a screw block 0702, and a plunger shaft 0703. The motor is controlled to move the shaft 0703 into or out of the screw block 0702. The end of shaft 0703 is connected to a bracket 0704 so that activation of the linear motor can cause the door 0705 to be opened or closed while rotating on hinges 0706.

The linear motor is activated by a button, switch, or some other means. If the door is opened and closed by a linear motor, it is not possible to open and close the door manually whether power is supplied to the machine or not.

During the Sabbath mode, the linear motor cannot be activated and the door remains closed, thus ensuring that no work is performed in violation of Sabbath laws.

One consideration is whether the door can be opened if there is no power to the LFC biodigester, or whether the door should remain locked shut in the absence of power. This is commonly referred to as failing secure or failing open.

In the case of the Sabbath mode, it is preferable that the door should remain unlocked in the absence of power. This will allow the door to be opened and waste can be put into the waste food machine. This action on the Sabbath would not cause work to be done or undone, thereby satisfying the Jewish law.

The activation and deactivation of Sabbath mode are detailed next. There are multiple ways in which the Sabbath mode can be activated and deactivated. Here are three examples:

The first method is by a user performing this action manually. This could be by the pressing of a button or flipping a switch. That could be a physical switch or a menu item on a screen. To deactivate the Sabbath mode, the user presses the same or a different button or switch. What is necessary is that momentary pressing of this button or switch should not take the machine out of the Sabbath mode accidentally.

If the machine has a touch screen, the menu item can be a button on the screen to activate the Sabbath mode. The screen should then go blank or show a simple indication that the machine is now in Sabbath mode. The screen should not change based on anything that the user may do. For example, if the screen usually shows the weight of waste in the drum, this must be disabled. To exit the Sabbath mode, the user has to press only the touch screen for a long time; for example, the user has to press for at least seven seconds to exit Sabbath mode.

A second method of activating and deactivating the waste food machine for Sabbath mode is to have the computer on the waste food machine have an embedded data base of the dates and times when the Sabbath should be observed. This may be achieved if the computer has a real time clock as part of its hardware. The problem with this approach is that unless the real time clock is accurate, the activation and deactivation of Sabbath mode may be at the wrong times.

An alternative of the second method is where the computer uses Network Time Protocol (NTP), Simple Network Time Protocol (SNTP), or some other means of obtaining the time from the internet to access the current date and time. The machine would need to be connected to the internet continually for this approach to work. If the internet fails for any reason, the machine may not observe the Sabbath properly.

A third method might be for the machine to access a server to obtain the dates and times of the Sabbath in accordance with halacha. Again, this would rely on the machine having internet access to an external server or the server may be on an internal intranet. It would also require the computer to have a real time clock, NTP, SNTP, or some other means of obtaining the current date and time. Thus, this third method has the disadvantages of the second method.

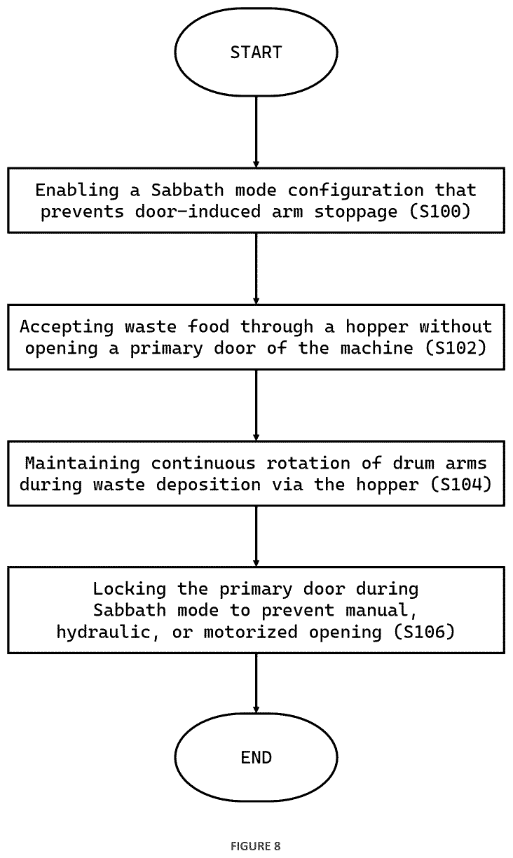

One implementation shown in FIG. 8 provides a method for operating a waste food machine that incorporates a special Sabbath mode to ensure uninterrupted operation in accordance with observance requirements. In one embodiment, the machine is configured to enable a Sabbath mode configuration that prevents the stopping of the machine by any user action. This feature, identified herein as S100, ensures that even if external factors would normally lead to the deactivation of the rotating drum arms upon opening the door, the mechanism permanently circumvents such stoppage while in Sabbath mode.

In addition to the above, the method allows the machine to accept waste food through a hopper, eliminating the need to open the primary door and thereby maintaining operational integrity during the deposition process. The drum arms continue to rotate as waste is introduced via the hopper, ensuring ongoing processing of the input material. Furthermore, during Sabbath mode, the primary door remains locked, precluding any attempt at its manual, hydraulic, or motorized opening. Collectively, these improvements result in a robust design that meets both practical operational demands and stringent adherence to time-honored observances.

In one embodiment, the waste processing apparatus further comprises one or more spring-loaded flap doors integrated within the hopper (S102) such that incoming waste is directed through these doors while maintaining sealing of the drum assembly. The spring-loaded flap doors are configured to open momentarily in response to the pressure exerted by deposited waste and then automatically return to a closed position under the bias of an attached spring, thereby ensuring that the drum maintains a consistent seal during continuous operation. The design of the flap doors facilitates controlled waste entry into the apparatus, allowing waste to be efficiently directed from the hopper into the continuously rotating drum arms (S104) without compromising the protective seal of the drum. Moreover, the inherent biasing of the flap doors minimizes the ingress of foreign matter or gaseous agents that could potentially disrupt the sealed condition of the drum during waste deposition, particularly when the apparatus is operating in Sabbath mode. The cooperative interaction between the spring-loaded flap doors and the other components, including the control mechanism (S100) and the primary door locking system (S106), further promotes reliable operation under conditions where manual intervention is limited.

In one embodiment, the locking mechanism for the primary door (S106) is configured by energizing an electro-magnet to secure the door to a chassis-mounted plate. The primary door incorporates an integrated ferromagnetic surface that, upon electro-magnet activation, is drawn to the chassis-mounted plate. When energized, the electro-magnet produces a magnetic field that engages the ferromagnetic material in the door, generating an attraction force that is sufficient to maintain the door in a locked position during Sabbath mode. This setup ensures that manual, hydraulic, or motorized forces are incapable of overcoming the magnetic locking force, effectively preventing the door from opening. In operation, a control unit initiates the energization of the electro-magnet concurrently with the activation of Sabbath mode. The energized state of the electro-magnet is sustained for the entire duration that the apparatus functions in Sabbath mode, thereby ensuring continuous locking of the primary door. Conversely, if the electro-magnet is selected to attract the ferromagnetic material in the absence of power (a system referred to as failing secure), then the electro-magnet is left without power during the Sabbath and is permanently energized at all other times. This design not only fulfills the requirement to prevent door-induced stoppage of the rotating drum arms but also complies with the operational constraints imposed during Sabbath observance by maintaining a secure, permanently closed door without the need for mechanical interlocks or additional active components.

In one embodiment, locking the primary door is achieved by disabling a linear motor actuator that controls door movement. When Sabbath mode is activated, a processor issues a command to render the linear motor actuator inoperative, thereby preventing any manual, hydraulic, or motorized door actuation. In certain embodiments, Sabbath mode is activated by toggling a physical switch on the machine; when the physical switch is engaged by the operator, an electrical signal is generated that initiates a sequence of commands, including disabling the linear motor actuator and engaging other Sabbath mode operational safeguards. In other exemplary embodiments, Sabbath mode is initiated by pressing a designated area on a touchscreen interface. In this case, the controller detects the touchscreen input, validates the operator's selection, and subsequently transitions the apparatus into Sabbath mode by executing preprogrammed instructions such as deactivating the linear motor actuator. Additionally, in some embodiments the controller is configured to automatically engage Sabbath mode based on preprogrammed dates and times stored in an onboard database synchronized with a real-time clock; when the clock indicates a predetermined time corresponding to Sabbath observance, the system automatically disables door movement by deactivating the linear motor actuator. In further embodiments, Sabbath mode activation is synchronized via internet-connected timekeeping protocols, such as NTP or SNTP, to validate current dates and times; the system receives authenticated time data from these protocols and, if the time matches Sabbath parameters, automatically initiates Sabbath mode. In still further embodiments, the apparatus queries an external server over a network to determine Sabbath status based on halachic parameters; upon receiving a response that indicates current conditions satisfy the required Sabbath observance criteria, the control unit automatically engages Sabbath mode by disabling the linear motor actuator and implementing the remaining operational constraints.

1. A method for operating a waste food machine in Sabbath mode, comprising:
providing a Sabbath mode configuration that prevents the stopping of the machine or modification of the machine's operation based on actions taken by the user;
accepting waste food through a hopper without opening a primary door of the machine;
maintaining continuous rotation of drum arms during waste deposition via the hopper;
locking the primary door during Sabbath mode to prevent manual, hydraulic, or motorized opening.

2. The method of claim 1, further comprising directing waste through one or more spring-loaded flap doors in the hopper to maintain drum sealing.

3. The method of claim 1, further comprising directing waste through one or more swinging flap doors that revert to a horizontal position under gravity in the hopper to maintain drum sealing.

4. The method of claim 1, further comprising depositing waste through one or more manually operated doors in the hopper.

5. The method of claim 1, wherein locking the primary door comprises energizing an electro-magnet to secure the door to a chassis-mounted plate.

6. The method of claim 1, wherein locking the primary door comprises extending a solenoid plunger into a bracket mounted on the door.

7. The method of claim 1, wherein locking the primary door comprises disabling a linear motor actuator controlling door movement.

8. The method of claim 1, further comprising activating Sabbath mode by toggling a physical switch on the machine.

9. The method of claim 1, further comprising initiating Sabbath mode by pressing a designated area on a touchscreen interface.

10. The method of claim 1, further comprising automatically engaging Sabbath mode based on preprogrammed dates and times in an onboard database synchronized with a real-time clock.

11. The method of claim 1, further comprising synchronizing Sabbath mode activation via internet-connected timekeeping protocols (such as NTP or SNTP) to validate the current dates and times.

12. The method of claim 1, further comprising querying an external server over a network to determine Sabbath status based on halachic parameters.

13. An apparatus with a Sabbath mode operation, comprising:
a waste food machine with a housing, at least one drum enclosed in the housing, arms within the drum that continually or continuously rotate, and at least one door coupled to the housing, wherein the door is openable by hand, by hydraulics, or by an electric motor, the opening of the door normally stopping the arms of the machine from turning for safety, regardless whether they were turning or not at the time the door is opened;
a hopper with one or more flap doors to allow the ingestion of waste food into the drum where the waste food can be placed into the machine without opening the door and without the possibility of stopping the arms from moving
wherein the door is locked in Sabbath mode by an electrically or electronically controlled actuator and cannot be opened.

14. The apparatus of claim 13, wherein the hopper has one or more manual doors to allow the ingestion of waste food into the drum.

15. The apparatus of claim 13, wherein the door usually used to put waste food into the waste food machine is (or doors are) locked in Sabbath mode by an electro-magnet and cannot be opened.

16. The apparatus of claim 13, wherein the door usually used to put waste food into the waste food machine is locked in Sabbath mode by an electro-plunger and cannot be opened.

17. The apparatus of claim 13, wherein the door usually used to put waste food into the waste food machine is controlled by a linear motor which is disabled in Sabbath mode and cannot be opened.

18. The apparatus of claim 13, wherein the Sabbath mode is entered and exited by pressing or toggling a switch.

19. The apparatus of claim 13, wherein the Sabbath mode is entered and exited by pressing an area on a touch screen.

20. The apparatus of claim 13, wherein the Sabbath mode is entered and exited by the computer in the machine having a built in data base that indicates the dates and times of the Sabbath mode and having a real time clock

21. The apparatus of claim 13, wherein the Sabbath mode is entered and exited by the computer in the machine having a built in data base that indicates the dates and times of the Sabbath mode and having access to the internet to obtain a current date and time to determine whether the Sabbath is in progress or not.
